(19) United States
(12) Patent Application Publication
(10) Pub. No.: US 2014/0236990 A1
(43) Pub. Date: Aug. 21, 2014

(54) MAPPING SURPRISAL DATA THROUGTH HADOOP TYPE DISTRIBUTED FILE SYSTEMS

(71) Applicant: INTERNATIONAL BUSINESS MACHINES CORPORATION, Armonk, NY (US)

(72) Inventors: Tom Deutsch, Costa Mesa, CA (US); Robert R. Friedlander, Southbury, CT (US); James R. Kraemer, Santa Fe, NM (US); Josko Silobrcic, Boston, MA (US)

(73) Assignee: INTERNATIONAL BUSINESS MACHINES CORPORATION, Armonk, NY (US)

(21) Appl. No.: 13/770,025

(22) Filed: Feb. 19, 2013

(51) Int. Cl. G06F 19/26

(52) U.S. Cl. CPC G06F 19/26
USPC 707/770

(57) ABSTRACT

A method, system and computer program product for reducing an amount of data representing a genetic sequence of an organism using a Hadoop type distributed file system. The method including the steps of breaking a surprisal data filter and an uncompressed genetic sequence into blocks of data of a fixed size; distributing the blocks of data to the plurality of worker nodes within the clusters and replicating the blocks of data within each of the worker nodes; tasking the plurality of worker nodes to perform a map job comprising mapping the surprisal data filter relative to the uncompressed genetic sequence; and when a worker node has reported a completion of the map job, tasking the worker node with a reduce job based on a specific key to an output of surprisal data and associated metadata.

### BACKGROUND

The present invention relates to gene sequencing, and more specifically to surprisal data reduction of genetic data through the use of a Hadoop type distributed file system.

DNA gene sequencing of a human, for example, generates about 3 billion (3×10⁹) nucleotide bases. Currently, if one wishes to transmit, store or analyze this data, all 3 billion nucleotide base pairs are transmitted, stored and analyzed. The storage of the data associated with the sequencing is significantly large, requiring at least 3 gigabytes of computer data storage space to store the entire genome which includes only nucleotide sequenced data and no other data or information such as annotations. The movement of the data between institutions, laboratories and research facilities is hindered by the significantly large amount of data and the significant amount of storage necessary to contain the data.

Many times during analysis, a sequence of an organism will need to be compared to a reference genome of the organism. Depending on the number of bases and length of the genome, the comparison can take a significant amount of time, especially when being carried out by only one computer processor.

A Hadoop® distributed file system (HDFS) is a system with a framework for running applications on a large cluster of commodity hardware which don't share any memory or disks. “Hadoop” is a registered trademark of The Apache Software Foundation. The HDFS software is executed on each piece of hardware.

The HDFS implements a computational paradigm named Map/Reduce, where the application is divided into many small fragments of work or blocks, each of which may be executed or re-executed on any node in the cluster. In addition, the HDFS stores data in the nodes, providing very high aggregate bandwidth across the cluster. It should be noted that any node failures of HDFS or Map/Reduce are automatically handled by the framework, since there are multiple copy stores and data can be automatically replicated from a known good copy.

### SUMMARY

According to one embodiment of the present invention, a method for reducing an amount of data representing a genetic sequence of an organism using a file distributed system comprising a series of clusters coupled together, each cluster having at least one master node and a plurality of worker nodes. The method comprising: a computer breaking a surprisal data filter and an uncompressed genetic sequence into blocks of data of a fixed size; the computer distributing the blocks of data to the plurality of worker nodes within the clusters and replicating the blocks of data within each of the worker nodes; the computer tasking the plurality of worker nodes to perform a map job comprising mapping the surprisal data filter relative to the uncompressed genetic sequence by: comparing nucleotides of the genetic sequence of the organism to nucleotides of the assigned part of the surprisal data filter, to find differences where nucleotides of the genetic sequence of the organism are different from the nucleotides of the surprisal data filter; storing intermediate surprisal data in a key and value format in a repository of the cluster, the intermediate surprisal data comprising at least a starting location of the differences within the surprisal data filter, and the nucleotides from the genetic sequence of the organism which are different from the nucleotides the surprisal data filter, discarding sequences of nucleotides that are the same in the genetic sequence of the organism; and reporting the status of the task to map the surprisal data filter to the uncompressed genetic sequence to the at least one master node of the cluster; when a worker node has reported a completion of the map job, the computer tasking the worker node with a reduce job based on a specific key, comprising: the worker node shuffling the intermediate surprisal data between the worker node and a plurality of worker nodes of other clusters, based on the specific key; the worker node reducing the intermediate surprisal data to an output of surprisal data and associated metadata.

According to another embodiment of the present invention, a computer program product for reducing an amount of data representing a genetic sequence of an organism using a file distributed system comprising a series of clusters coupled together, each cluster having at least one master node and a plurality of worker nodes. The computer program product comprising: one or more computer-readable, tangible storage devices; program instructions, stored on at least one of the one or more storage devices, to break a surprisal data filter and an uncompressed genetic sequence into blocks of data of a fixed size; program instructions, stored on at least one of the one or more storage devices, to distribute the blocks of data to the plurality of worker nodes within the clusters and replicating the blocks of data within each of the worker nodes; program instructions, stored on at least one of the one or more storage devices, to task the plurality of worker nodes to perform a map job comprising mapping the surprisal data filter relative to the uncompressed genetic sequence by: comparing nucleotides of the genetic sequence of the organism to nucleotides of the assigned part of the surprisal data filter, to find differences where nucleotides of the genetic sequence of the organism are different from the nucleotides of the surprisal data filter; storing intermediate surprisal data in a key and value format in a repository of the cluster, the intermediate surprisal data comprising at least a starting location of the differences within the surprisal data filter, and the nucleotides from the genetic sequence of the organism which are different from the nucleotides the surprisal data filter, discarding sequences of nucleotides that are the same in the genetic sequence of the organism; and reporting the status of the task to map the surprisal data filter to the uncompressed genetic sequence to the at least one master node of the cluster; when a worker node has reported a completion of the map job, program instructions, stored on at least one of the one or more storage devices, to task the worker node with a reduce job based on a specific key, comprising: the worker node shuffling the intermediate surprisal data between the worker node and a plurality of worker nodes of other clusters, based on the specific key; the worker node reducing the intermediate surprisal data to an output of surprisal data and associated metadata.

According to another embodiment of the present invention, a system for reducing an amount of data representing a genetic sequence of an organism using a file distributed system comprising a series of clusters coupled together, each cluster having at least one master node and a plurality of worker nodes. The system comprising: one or more processors, one or more computer-readable memories and one or more computer-readable, tangible storage devices; program instructions, stored on at least one of the one or more storage devices for execution by at least one of the one or more processors via at least one of the one or more memories, to break a surprisal data filter and an uncompressed genetic sequence into blocks of data of a fixed size; program instructions, stored on at least one of the one or more storage devices for execution by at least one of the one or more processors via at least one of the one or more memories, to distribute the blocks of data to the plurality of worker nodes within the clusters and replicating the blocks of data within each of the worker nodes; program instructions, stored on at least one of the one or more storage devices for execution by at least one of the one or more processors via at least one of the one or more memories, to task the plurality of worker nodes to perform a map job comprising mapping the surprisal data filter relative to the uncompressed genetic sequence by: comparing nucleotides of the genetic sequence of the organism to nucleotides of the assigned part of the surprisal data filter, to find differences where nucleotides of the genetic sequence of the organism are different from the nucleotides of the surprisal data filter; storing intermediate surprisal data in a key and value format in a repository of the cluster, the intermediate surprisal data comprising at least a starting location of the differences within the surprisal data filter, and the nucleotides from the genetic sequence of the organism which are different from the nucleotides the surprisal data filter, discarding sequences of nucleotides that are the same in the genetic sequence of the organism; and reporting the status of the task to map the surprisal data filter to the uncompressed genetic sequence to the at least one master node of the cluster; when a worker node has reported a completion of the map job, program instructions, stored on at least one of the one or more storage devices for execution by at least one of the one or more processors via at least one of the one or more memories, to task the worker node with a reduce job based on a specific key, comprising: the worker node shuffling the intermediate surprisal data between the worker node and a plurality of worker nodes of other clusters, based on the specific key; the worker node reducing the intermediate surprisal data to an output of surprisal data and associated metadata.

### BRIEF DESCRIPTION OF THE SEVERAL VIEWS OF THE DRAWINGS

FIG. 1 depicts an exemplary diagram of a possible data processing environment in which illustrative embodiments may be implemented.

FIG. 2 shows a flowchart of a method of mapping surprisal data using a Hadoop type distributed file system.

FIG. 3 shows a schematic of multiple clusters of a Hadoop type distributed file system for mapping genetic surprisal data.

FIG. 4 shows a schematic of a specific cluster of the Hadoop type distributed file system.

FIG. 5 illustrates internal and external components of a client computer and a server computer in which illustrative embodiments may be implemented.

### DETAILED DESCRIPTION

The illustrative embodiments of the present invention recognize that the difference between the genetic sequence from two humans is about 0.1%, which is one nucleotide difference per 1000 base pairs or approximately 3 million nucleotide differences. The difference may be a single nucleotide polymorphism (SNP) (a DNA sequence variation occurring when a single nucleotide in the genome differs between members of a biological species), or the difference might involve a sequence of several nucleotides. The illustrative embodiments recognize that most SNPs are neutral but some, 3-5% are functional and influence phenotypic differences between species through alleles. Furthermore that approximately 10 to 30 million SNPs exist in the human population of which at least 1% are functional.

The illustrative embodiments also recognize that with the small amount of differences present between the genetic sequence from two humans, the “common” or “normally expected” sequences of nucleotides can be compressed out or removed to arrive at “surprisal data”—differences of nucleotides which are “unlikely” or “surprising” relative to the common sequences, for example of a filter.

The dimensionality of the data reduction that occurs by removing the “common” sequences is 10³, such that the number of data items and, more important, the interaction between nucleotides, is also reduced by a factor of approximately 10³—that is, to a total number of nucleotides remaining is on the order of 10³.

The illustrative embodiments also recognize that by identifying what sequences are “common” or provide a “normally expected” value within a genome, and knowing what data is “surprising” or provides an “unexpected value” relative to the normally expected value, the only data needed to recreate the entire genome in a lossless manner is the surprisal data and the genome used to obtain the surprisal data.

The illustrative embodiments recognize that a surprisal data filter is a filter associated with the identified characteristics of a generated hierarchy from reference genomes and was created by combining pieces of the reference genomes that match or correspond with identified characteristics. The illustrative embodiments also recognize that surprisal data filter are user specific and are tailored based on user input and a hierarchy of characteristics.

The illustrative embodiments recognize that by using a distributed type file system, for example a Hadoop® distributed file system (HDFS), comparing a genetic sequence to a surprisal data filter for an entire genome can be reduced into small fragments of blocks or sub-parts to be executed or re-executed on any node of the cluster and the data from this comparison can be combined and reduced to one output file, allowing the identification of what sequences are “common” or provide a “normally expected” value vs. surprising or surprisal data within a genome to be conducted in a significantly less amount of time and be stored in significantly using less space.

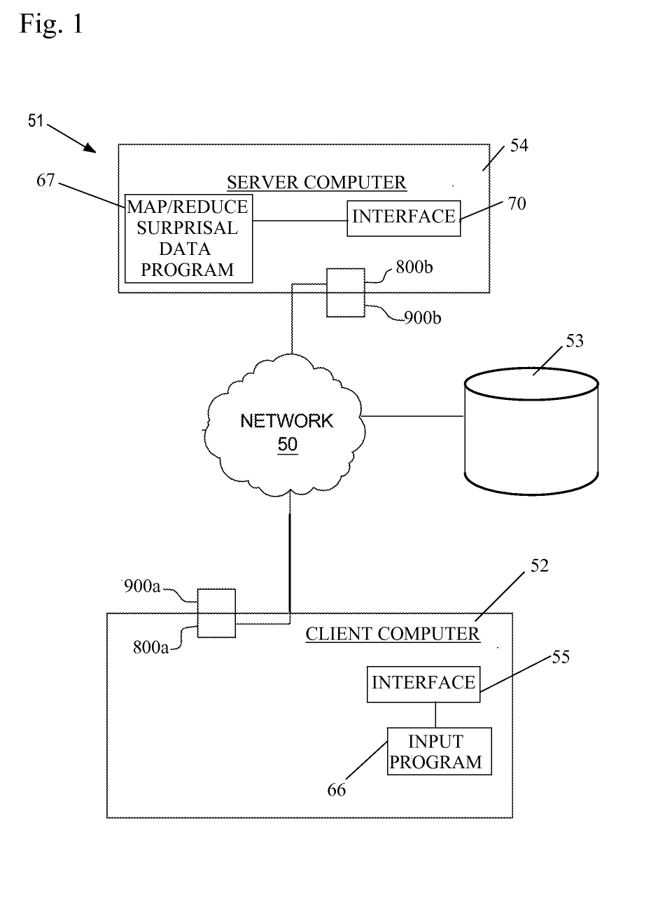

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

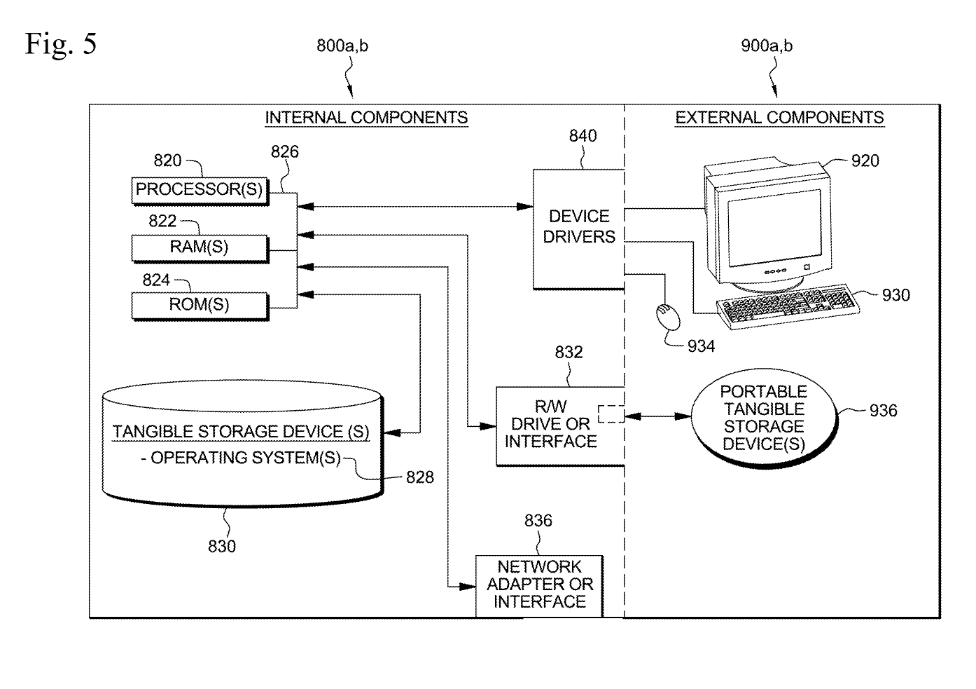

In the depicted example, a client computer 52, server computer 54, and a repository 53 connect to network 50. In other exemplary embodiments, network data processing system 51 may include additional client computers, storage devices, server computers, and other devices not shown. The client computer 52 includes a set of internal components 800a and a set of external components 900a, further illustrated in FIG. 5. The client computer 52 may be, for example, a mobile device, a cell phone, a personal digital assistant, a netbook, a laptop computer, a tablet computer, a desktop computer, or any other type of computing device.

Client computer 52 may contain an interface 55. The interface can be, for example, a command line interface, a graphical user interface (GUI), or a web user interface (WUI). The interface 55 may be used, for example for selecting surprisal data filters, or viewing the reduced output file of surprisal data and associated metadata.

In the depicted example, server computer 54 provides information, such as boot files, operating system images, and applications to client computer 52. Server computer 54 can compute the information locally or extract the information from other computers on network 50. Server computer 54 includes an interface 70. The interface 70 can be, for example, a command line interface, a graphical user interface (GUI), or a web user interface (WUI). The interface 70 may be used, for example for monitoring the progress of the function of the map/reduce computational paradigm or viewing clusters. Server computer 54 includes a set of internal components 800b and a set of external components 900b illustrated in FIG. 5 and may also include the components shown in FIG. 5.

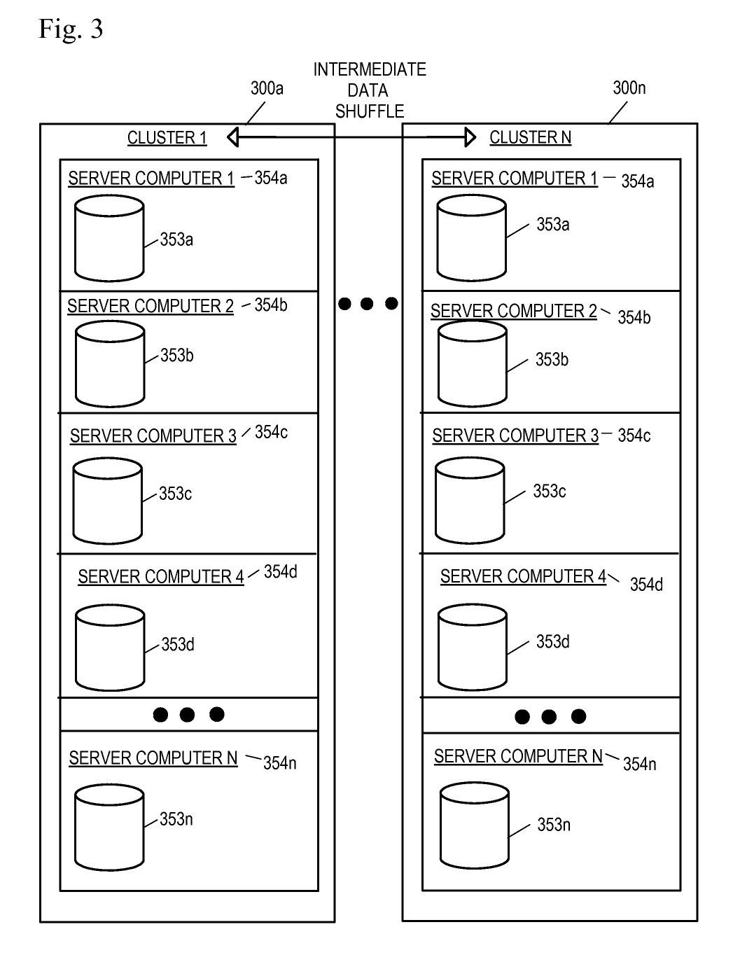

Program code and programs such as an input program 66, and a map/reduce surprisal data program 67 may be stored on at least one of one or more computer-readable tangible storage devices 830 shown in FIG. 5, on at least one of one or more portable computer-readable tangible storage devices 936 as shown in FIG. 5, repositories 353a-353n as shown in FIG. 3, or repository 53 connected to network 50, or downloaded to a data processing system or other device for use. For example, program code, an input program 66 and a map/reduce surprisal data program 67 may be stored on at least one of one or more tangible storage devices 830 on server computer 54 and downloaded to client computer 52 over network 50 for use on client computer 52. Alternatively, server computer 54 can be a web server, and the program code, an input program 66 and a map/reduce surprisal data program 67 may be stored on at least one of the one or more tangible storage devices 830 on server computer 54 and accessed on client computer 52. Input program 66 can be accessed on client computer 52 through interface 55. Map/reduce surprisal data program 67 can be accessed on the server computer 54. In other exemplary embodiments, the program code and programs such as an input program 66 and a map/reduce surprisal data program 67 may be stored on at least one of one or more computer-readable tangible storage devices 830 on client computer 52 or distributed between two or more servers.

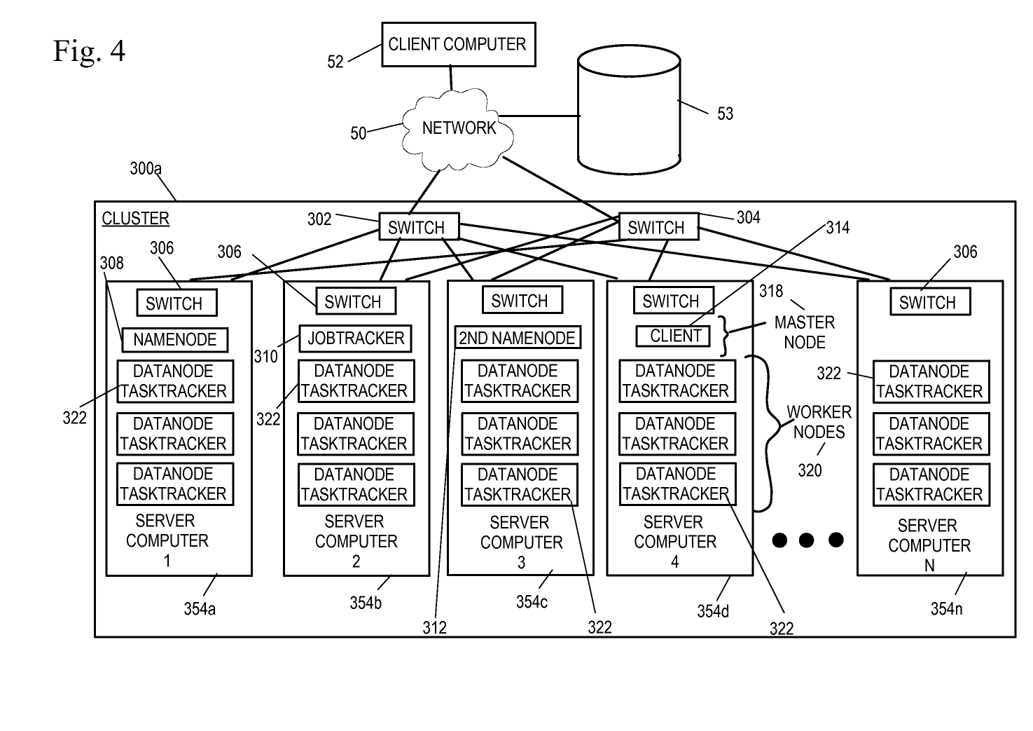

Referring to FIGS. 3 and 4, within a Hadoop distributed file system (HDFS), are a series of clusters 300a, 300n, with only one cluster being shown in FIG. 4 and multiple clusters being shown in FIG. 3. It should be noted that “n” may be any number greater than 1. Each cluster 300a-300n may for example include multiple rack servers populated in racks, for example server computers 354a, 354b, 354c, 354d, 354n and connected to a rack switch 306 within each rack which is further connected to another series of switches 302, 304 which connects all other racks or clusters of racks together with a uniform bandwidth. The switches 302, 304 are connected to a network 50. The network is also connected to a repository 53 and a client computer 52.

Each of the clusters 300a-300n have local HDFS repositories 353a-353n for each server computer 354a-354n, for example as shown in FIG. 3. Individual server computers within each cluster are referred to as DataNodes. There are different types of DataNodes, for example a master node 318 and a slave or worker node 320. The master node 318 consists of a JobTracker 310, Client 314, NameNode 308 and secondary NameNode 312. A slave or worker node 320 acts as both a DataNode and TaskTracker 322. It should be noted that a master node 318 may include both a DataNode and a TaskTracker 322 depending on the size of the system.

The JobTracker 310 manages job scheduling and schedules map/reduce jobs or tasks to TaskTrackers 322 or other nodes in the cluster. The JobTracker 310 has an awareness of location of the data necessary for the job or task, for example comparing uncompressed genetic sequence to a surprisal data filter. The TaskTracker 322 is the node in the cluster that accepts tasks.

The Namenode 308 is the single point for storage and management of metadata and keeps the directory tree of all files in the file system and tracks where across the cluster the file data is stored. An additional or secondary Namenode 312 may be present to build snapshots of the primary NameNode's 308 directory of information which is stored in a remote directory or respository in case of system failure. The NameNode 312 points Client 314 to the DataNodes 322 they need to talk to and keeps track of the cluster's storage capacity, the health of each Data Node 322, and making sure each block of data is meeting the minimum defined replica policy.

The DataNode 322 stores data for the task or job in the HDFS. Within the HDFS more than one DataNode 322 is present and data is spread across them.

The Client 314 talks to the NameNode 308 whenever a file needs to be located, or when a file needs to be added, copied, moved, or deleted. The Client 314 breaks whatever incoming file, for example the uncompressed genetic sequence and the surprisal data filter into smaller “blocks” and places the blocks of data on the different machines or nodes of the cluster. For each block of data, the Client 314 consults the NameNode 308 responds with DataNodes 322 that should contain the block and the receiving DataNode 322 replicates the block to other DataNodes within the cluster.

A client computer 52 is connected to the clusters 300a, 300n through a network 50 and initially loads data into the clusters, for example through the input program 66, describes how the data is to be mapped and reduced and views the results of the map/reduction of the inputted data.

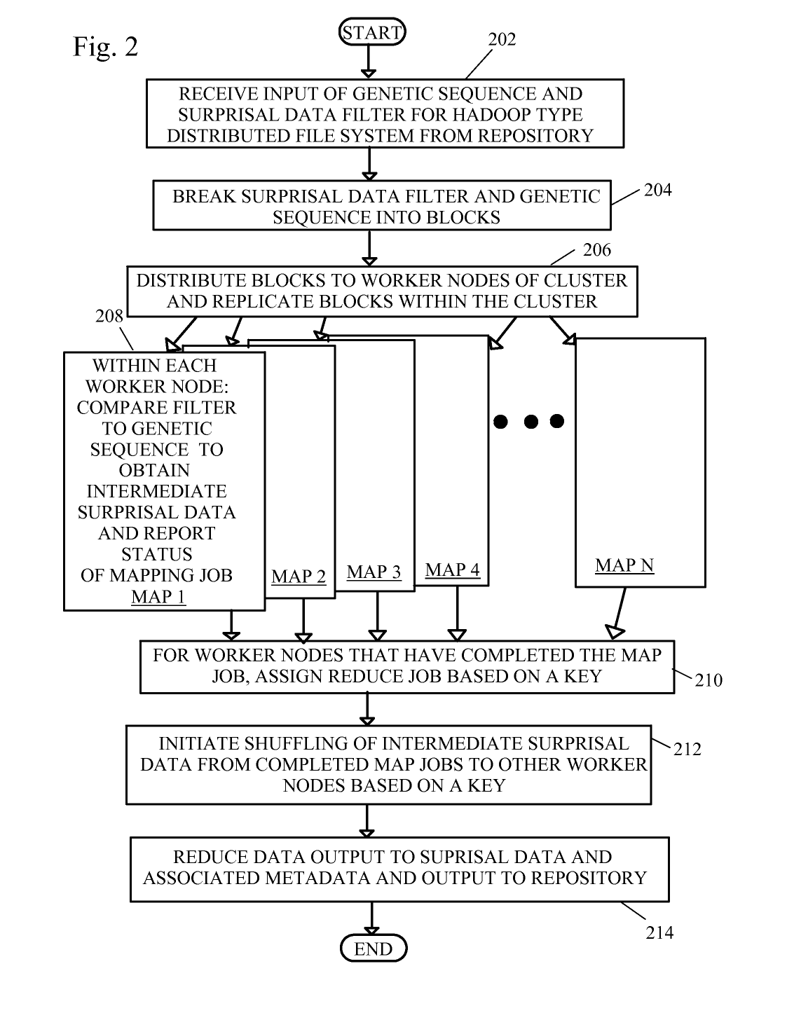

FIG. 2 shows flowchart of a method of mapping genetic surprisal data using a Hadoop type file distributed system. In a first step, the HDFS receives an input of an uncompressed genetic sequence and surprisal data filter from a repository (step 202), for example repository 53 from a client computer through an input program 66.

The uncompressed genetic sequence of an organism may be a DNA sequence, an RNA sequence, or a nucleotide sequence and may represent a sequence or a genome of an organism. The organism may be a fungus, microorganism, human, animal or plant.

The surprisal data filter is a filter associated with the identified characteristics of a generated hierarchy from reference genomes and was created by combining pieces of the reference genomes that match or correspond with identified characteristics. A reference genome is a digital nucleic acid sequence database which includes numerous sequences. The sequences of the reference genome do not represent any one specific individual's genome, but serve as a starting point for broad comparisons across a specific species, since the basic set of genes and genomic regulator regions that control the development and maintenance of the biological structure and processes are all essentially the same within a species. In other words, the reference genome is a representative example of a species' set of genes. A surprisal data filter is user specific and tailored reference genome based on user input and hierarchy of characteristics.

The surprisal data filter and the uncompressed genetic sequence are broken into sub-parts or blocks of data of a fixed size (step 204), for example by the Client 314, a master node 318, through the input program 66. The sub-parts or blocks of data are distributed to the worker nodes within the cluster and replicated within each of the clusters (step 206), for example by the Client 314, a master node 318, through the input program 66.

Within each worker node tasked with a “map job”, the block of surprisal data filter is mapped or compared to the block of the uncompressed genetic sequence to find surprisal data, and the surprisal data is stored in a repository and the status of the map task is reported to a master node (step 208), for example through the map/reduce surprisal data program 67.

The surprisal data is defined as at least one nucleotide difference that provides an “unexpected value” relative to the normally expected value of the surprisal data filter. In other words, the surprisal data contains at least one nucleotide difference present when comparing the sequence to the surprisal data filter. The surprisal data that is actually stored in the repository preferably includes a location of the difference within the surprisal data filter, the number of nucleotides that are different, and the actual changed nucleotides.

It should be noted that the mapping takes place on multiple machines within the cluster and within multiple clusters with the local data within the cluster. The surprisal data that is found by each worker node through the mapping is only for comparison of the block or sub-part within each worker node and is considered intermediate data. The intermediate data from the mapping of step 208 of the input of the surprisal data filter and the uncompressed genetic sequence is in a format of pairs of a key and value.

For example, the intermediate surprisal data may have a key number, which could be a scalar (say, 1) or a two-dimensional key (1, 312), or other key structures known to the art. For example, the key (1, 312) corresponding to a nucleotide “a” might indicate gene number 1 and position 312 of the nucleotide within gene 1 within the surprisal data filter. The nucleotide “a” located at this key (1, 312) is “surprising” when comparing the surprisal data filter to the uncompressed genetic sequence. Other data relating to the surprisal data filter and the uncompressed genetic sequence may be part of the key and value pairs.

Referring to FIG. 4, within the HDFS, to execute step 208, the Client 314 submits the job to the JobTracker 310. The JobTracker 310 consults the NameNode 308 to determine which DataNodes 322 have the blocks necessary to complete the job. The JobTracker 310 than provides the TaskTracker 322 associated with the DataNodes with the code to execute the mapping of the uncompressed genetic sequence relative to the surprisal data filter to determine surprisal data on the local data within the DataNodes 322 (a “map job”). The TaskTracker 322 starts the “map job” and monitors the progress. The TaskTracker 322 provides a status regarding the “map job” to the JobTracker 310.

Referring back to FIG. 2, the worker nodes that have completed the “map job” are assigned a “reduce job” based on a key (step 210), for example through the map/reduce surprisal data program 67.

The intermediate surprisal data from the worker nodes that have completed the map job are shuffled to other worker nodes based on the key of the assigned reduce task (step 212), for example through the map/reduce surprisal data program 67 by a master node. The key, for example may be gene number.

The master node instructs worker nodes to reduce the intermediate surprisal data and output surprisal data and associated metadata and store the output to a repository (step 214), for example repository 53 through the map/reduce surprisal data program 67. The associated metadata preferably includes an indication of the surprisal data filter used, a location of a difference in the surprisal data filter, the number of bases that were different at the location within the surprisal data filter, and the actual bases that are different than bases in the surprisal data filter at the location.

Referring to FIG. 4, the JobTracker 310 starts a “reduce job” on any one of the worker nodes 320 in the cluster and instructs the worker node 320 to exchange intermediate data based on key with the other worker nodes 320 that have completed the map task. Once the intermediate data has been exchanged, the data is reduced by the worker nodes 320 based on key by the TaskTracker 322. The output of the reduced job or task is stored in a repository 53 and may be read by the Client 314 and/or the client computer 52.

FIG. 5 illustrates internal and external components of client computer 52 and server computer 54 in which illustrative embodiments may be implemented. In FIG. 5, client computer 52 and server computer 54 include respective sets of internal components 800a, 800b, and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, an input program 66 and a map/reduce surprisal data program 67 are stored on one or more of the computer-readable tangible storage devices 830 for execution by one or more of the processors 820 via one or more of the RAMs 822 (which typically include cache memory). In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. An input program 66 and a map/reduce surprisal data program 67 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. An input program 66 and a map/reduce surprisal data program 67 can be downloaded to client computer 52 and server computer 54 from an external computer via a network (for example, the Internet, a local area network or other, wide area network) and network adapter or interface 836. From the network adapter or interface 836, an input program 66 and a map/reduce surprisal data program 67 are loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

An input program 66 and a map/reduce surprisal data program 67 can be written in various programming languages including low-level, high-level, object-oriented or non object-oriented languages. Alternatively, the functions of an input program 66 and a map/reduce surprisal data program 67 can be implemented in whole or in part by computer circuits and other hardware (not shown).

Based on the foregoing, a computer system, method and program product have been disclosed for reducing an amount of data representing a genetic sequence of an organism using a file distributed system. However, numerous modifications and substitutions can be made without deviating from the scope of the present invention. Therefore, the present invention has been disclosed by way of example and not limitation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for reducing an amount of data representing a genetic sequence of an organism using a file distributed system comprising a series of clusters coupled together, each cluster having at least one master node and a plurality of worker nodes, comprising:
a computer breaking a surprisal data filter and an uncompressed genetic sequence into blocks of data of a fixed size;
the computer distributing the blocks of data to the plurality of worker nodes within the clusters and replicating the blocks of data within each of the worker nodes;
the computer tasking the plurality of worker nodes to perform a map job comprising mapping the surprisal data filter relative to the uncompressed genetic sequence by:
comparing nucleotides of the genetic sequence of the organism to nucleotides of the assigned part of the surprisal data filter, to find differences where nucleotides of the genetic sequence of the organism are different from the nucleotides of the surprisal data filter;
storing intermediate surprisal data in a key and value format in a repository of the cluster, the intermediate surprisal data comprising at least a starting location of the differences within the surprisal data filter, and the nucleotides from the genetic sequence of the organism which are different from the nucleotides the surprisal data filter, discarding sequences of nucleotides that are the same in the genetic sequence of the organism; and
reporting the status of the task to map the surprisal data filter to the uncompressed genetic sequence to the at least one master node of the cluster;
when a worker node has reported a completion of the map job, the computer tasking the worker node with a reduce job based on a specific key, comprising:
the worker node shuffling the intermediate surprisal data between the worker node and a plurality of worker nodes of other clusters, based on the specific key;
the worker node reducing the intermediate surprisal data to an output of surprisal data and associated metadata.

2. The method of claim 1, wherein the associated metadata comprises: an indication of the surprisal data filter used; a location of a difference in the surprisal data filter, a number of nucleotides that were different at the location within the surprisal data filter, and actual nucleotides that are different than nucleotides in the surprisal data filter at the location.

3. The method of claim 1, further comprising the computer receiving an input of the uncompressed genetic sequence and the surprisal data filter from a repository.

4. The method of claim 1, wherein the organism is an animal.

5. The method of claim 1, wherein the organism is a microorganism.

6. The method of claim 1, wherein the organism is a plant.

7. The method of claim 1, wherein the organism is a fungus.

8. A computer program product for reducing an amount of data representing a genetic sequence of an organism using a file distributed system comprising a series of clusters coupled together, each cluster having at least one master node and a plurality of worker nodes, the computer program product comprising:
one or more computer-readable, tangible storage devices;
program instructions, stored on at least one of the one or more storage devices, to break a surprisal data filter and an uncompressed genetic sequence into blocks of data of a fixed size;
program instructions, stored on at least one of the one or more storage devices, to distribute the blocks of data to the plurality of worker nodes within the clusters and replicating the blocks of data within each of the worker nodes;
program instructions, stored on at least one of the one or more storage devices, to task the plurality of worker nodes to perform a map job comprising mapping the surprisal data filter relative to the uncompressed genetic sequence by:
comparing nucleotides of the genetic sequence of the organism to nucleotides of the assigned part of the surprisal data filter, to find differences where nucleotides of the genetic sequence of the organism are different from the nucleotides of the surprisal data filter;
storing intermediate surprisal data in a key and value format in a repository of the cluster, the intermediate surprisal data comprising at least a starting location of the differences within the surprisal data filter, and the nucleotides from the genetic sequence of the organism which are different from the nucleotides the surprisal data filter, discarding sequences of nucleotides that are the same in the genetic sequence of the organism; and
reporting the status of the task to map the surprisal data filter to the uncompressed genetic sequence to the at least one master node of the cluster;
when a worker node has reported a completion of the map job, program instructions, stored on at least one of the one or more storage devices, to task the worker node with a reduce job based on a specific key, comprising:
the worker node shuffling the intermediate surprisal data between the worker node and a plurality of worker nodes of other clusters, based on the specific key;
the worker node reducing the intermediate surprisal data to an output of surprisal data and associated metadata.

9. The computer program product of claim 8, wherein the associated metadata comprises: an indication of the surprisal data filter used; a location of a difference in the surprisal data filter, a number of nucleotides that were different at the location within the surprisal data filter, and actual nucleotides that are different than nucleotides in the surprisal data filter at the location.

10. The computer program product of claim 8, further comprising program instructions, stored on at least one of the one or more storage devices, to receive an input of the uncompressed genetic sequence and the surprisal data filter from a repository.

11. The computer program product of claim 8, wherein the organism is an animal.

12. The computer program product of claim 8, wherein the organism is a microorganism.

13. The computer program product of claim 8, wherein the organism is a plant.

14. The computer program product of claim 8, wherein the organism is a fungus.

15. A system for reducing an amount of data representing a genetic sequence of an organism using a file distributed system comprising a series of clusters coupled together, each cluster having at least one master node and a plurality of worker nodes, the system comprising:
one or more processors, one or more computer-readable memories and one or more computer-readable, tangible storage devices;
program instructions, stored on at least one of the one or more storage devices for execution by at least one of the one or more processors via at least one of the one or more memories, to break a surprisal data filter and an uncompressed genetic sequence into blocks of data of a fixed size;
program instructions, stored on at least one of the one or more storage devices for execution by at least one of the one or more processors via at least one of the one or more memories, to distribute the blocks of data to the plurality of worker nodes within the clusters and replicating the blocks of data within each of the worker nodes;
program instructions, stored on at least one of the one or more storage devices for execution by at least one of the one or more processors via at least one of the one or more memories, to task the plurality of worker nodes to perform a map job comprising mapping the surprisal data filter relative to the uncompressed genetic sequence by:
comparing nucleotides of the genetic sequence of the organism to nucleotides of the assigned part of the surprisal data filter, to find differences where nucleotides of the genetic sequence of the organism are different from the nucleotides of the surprisal data filter;
storing intermediate surprisal data in a key and value format in a repository of the cluster, the intermediate surprisal data comprising at least a starting location of the differences within the surprisal data filter, and the nucleotides from the genetic sequence of the organism which are different from the nucleotides the surprisal data filter, discarding sequences of nucleotides that are the same in the genetic sequence of the organism; and
reporting the status of the task to map the surprisal data filter to the uncompressed genetic sequence to the at least one master node of the cluster;
when a worker node has reported a completion of the map job, program instructions, stored on at least one of the one or more storage devices for execution by at least one of the one or more processors via at least one of the one or more memories, to task the worker node with a reduce job based on a specific key, comprising:
the worker node shuffling the intermediate surprisal data between the worker node and a plurality of worker nodes of other clusters, based on the specific key;
the worker node reducing the intermediate surprisal data to an output of surprisal data and associated metadata.

16. The system of claim 15, wherein the associated metadata comprises: an indication of the surprisal data filter used; a location of a difference in the surprisal data filter, a number of nucleotides that were different at the location within the surprisal data filter, and actual nucleotides that are different than nucleotides in the surprisal data filter at the location.

17. The system of claim 15, further comprising program instructions, stored on at least one of the one or more storage devices for execution by at least one of the one or more processors via at least one of the one or more memories, to receive an input of the uncompressed genetic sequence and the surprisal data filter from a repository.

18. The system of claim 15, wherein the organism is an animal.

19. The system of claim 15, wherein the organism is a microorganism.

20. The system of claim 15, wherein the organism is a plant.

21. The system of claim 15, wherein the organism is a fungus.
